(19) United States
(12) Patent Application Publication
(10) Pub. No.: US 2014/0190306 A1
(43) Pub. Date: Jul. 10, 2014

(54) BICYCLE HANDLE

(71) Applicant: RTI SPORTS VERTRIEB VON SPORTARTIKELN GmbH, Koblenz (DE)

(72) Inventors: Kim Tofaute, Lahnstein (DE); Jan Ernst Holzschuher, Koblenz (DE); Franc Arnold, Koblenz (DE)

(21) Appl. No.: 14/237,695

(22) PCT Filed: Aug. 15, 2012
(86) PCT No.: PCT/EP2012/065965

§ 371 Date: Feb. 7, 2014

(30) Foreign Application Priority Data
Aug. 24, 2011 (DE) 20 2011 104 764.8

(51) Int. Cl. B62K 21/12

(52) U.S. Cl. CPC B62K 21/125
USPC 74/551.8

(57) ABSTRACT

A bicycle handle which is suitable in particular for curved handlebars has an inner part which has an opening for receiving the handlebar. The inner part merges into an outer part. To compensate for the curvature of the handlebar, the outer part is angled relative to the inner part. An ergonomic hand position is attained in this way.

### BACKGROUND

1. Field of the Disclosure

The disclosure relates to a bicycle handle, in particular for curved handle-bars.

2. Discussion of the Background Art

An ergonomic bicycle handle is known from EP 1 537 014, for example. The same comprises a support element for the ball of the thumb, which in the mounted state is directed towards the rider. The element is an extension whose top face forms a support surface for the ball of the thumb. In the mounted state, the support surface for the ball of the thumb is oriented substantially horizontally. Owing to such an ergonomic support of the ball of the thumb, a bending of the wrist, as it occurs with conventional cylindrical bicycle handles is avoided or at least reduced. The forearm thus passes substantially linearly into the hand so that specifically the problem of the fingers going numb during long rides is avoided. Further, the support surface for the ball of the thumb, which in particular has a soft or resilient surface, provides for relief of the hand. This means an enhancement of comfort.

Studies have shown that such ergonomically designed bicycle handles do not result in the desired relief of the hand with all handlebar shapes. Especially with curved handlebars, i.e. handlebars curved towards the rider, the desired relief of the hand can at least not be achieved to the full extent with such handles. This type of handlebars is frequently used for touring bicycles.

It is an object of the disclosure to provide a bicycle handle with which a relief of the hand can be achieved also with curved handlebars.

### SUMMARY

The bicycle handle of the disclosure, suitable in particular for curved handlebars, comprises an inner part and an outer part. The inner part is the part of the handle which, in the mounted state, is directed inward towards the handlebar stem. The outer part adjoins the inner part in the outward direction. With a conventional bicycle handlebar, the inner and outer parts would form a common hollow-cylindrical element. According to the disclosure, the outer part is angled with respect to the inner part. When mounted, the bicycle handle of the disclosure thus has an angled or curved shape, seen in top plan view. In the mounted state, the angular offset of the outer part is such that the outer part is angled outward. With a curved handlebar, whose handlebar ends are curved towards the rider opposite to the traveling direction, this curvature of the handlebar is counteracted by the outer part of the bicycle handlebar. With reference to the traveling direction or the centre plane of the frame, the outer part of the handle or a centre line of the outer part of the handle encloses a larger angle with the traveling direction than the handlebar end of the curved handlebar.

In a standard gripping position, in which the rider substantially grips the outer part of the bicycle handlebar, the angled outer part causes an inward rotation of the wrist. With curved handlebars having a conventional cylindrical bicycle handle, the wrist is angled outward so that an angular offset exists between an outer side of the forearm and an outer side of the palm in the region of the little finger. By using the present angled bicycle handle with curved handlebars, the wrist is turned back inwards. The angle between the outer side of the forearm and the corresponding part of the palm thus encloses a larger angle. Ideally, the outer side of the forearm passes substantially linearly into the outer side of the palm. In this ideal position, the wrist of the rider is no longer angled, seen in top plan view. This allows for a significant enhancement of ergonomics. The risk of the fingers going numb is drastically reduced thereby.

In a preferred embodiment of the bicycle handlebar of the present disclosure, a centre line of the outer part encloses an angle with respect to a centre line of the inner part. The same preferably lies in a range from 100°-170°, the angle being measured in the mounted state of the bicycle handlebar at the front edge of the handle directed in the traveling direction. Preferably, the angle is in a range from 120°-150° and, particularly preferred, from 130°-140°. Preferably, the angular range is selected as a function of the curvature of the handlebar. Ideally, the angle compensates for the handlebar curvature such that, when mounted, the outer of the bicycle handle has a centre line which, if the handlebar is in a level position, is substantially perpendicular to the traveling direction or perpendicular to the centre plane of the frame. If necessary, the outer part may be inclined slightly towards the rider so that an angle of 0°-30° exists between the centre line of the outer part and a perpendicular line to the centre plane of the bicycle.

In particularly preferred embodiment the angular offset of the outer part relative to the inner part is such that a common front edge of the inner part and the outer part, which is directed in the traveling direction when in the mounted state, has a concave curvature. Thereby, a smooth continuous transition is realized in the region of the front edge, resulting in a pleasant grip feeling.

Preferably, the outer side of the inner part merges smoothly with the outer side of the outer part. The entire surface of the bicycle handle is thus preferably configured to be smooth or stepless. Thereby, the occurrence of unpleasant pressure marks.

For a further enhancement of the ergonomics of the bicycle handle, the outer part may in addition be connected, in particular formed integrally with a support element for the ball of the thumb. In this case, in the mounted state of the bicycle handle, the support element for the ball of the thumb is directed opposite to the traveling direction, i.e. towards the rider. Corresponding to the support element for the ball of the thumb described in EP 1 537 014, the support element for the ball of the thumb serves to rest the ball of the thumb thereon and thus to relieve the wrist. Preferably, the support element for the ball of the thumb is designed such that a rear edge, i.e. the edge of the support element for the ball of the thumb directed towards the rider in the mounted state of the bicycle handle, extends substantially parallel to the centre line of the outer part. Here, the rear edge and the centre line preferably deviate from the parallel line by less than ±10°.

In another preferred embodiment, a bulge is provided at an upper side of the outer part, preferably in addition to the support element for the ball of the thumb. Owing to this hill-shaped bulge at the upper side of the outer part, the correction of the hand position can be further assisted.

Preferably, the bicycle handle is structured such that an inner sleeve of a preferably harder material is surrounded by the inner part that is preferably made of a softer material. Possibly, the sleeve also protrudes at least partially into the outer part of the bicycle handle. In this case, the sleeve is designed such that an inner side of the sleeve abuts against the outer side of the handlebar, when the same is in the mounted state. The preferably hollow cylindrically shaped sleeve thus preferably lines the bicycle handle opening that serves to receive the handlebar. Thereby, a secure retention of the bicycle handle on the handlebar can be achieved. In this regard, it is particularly preferred that the bicycle handle is fixed by means of a clamping element. This is particularly advantageous in combination with a sleeve, since the clamping element, which is bracket-shaped for instance, can surround a free end of the sleeve so that the sleeve is clampingly fixed on the outer side of the handlebar by closing the clamping element.

In a preferred embodiment, the sleeve is connected or integrally formed with an in particular wing-shaped protrusion. This protrusion protrudes into the support element for the ball of the thumb in a skeleton-like manner and thus serves to stiffen the support element for the ball of the thumb. In particular, if the bicycle handle of the disclosure comprises a support element for the ball of the thumb, it is particularly preferred to provide such a sleeve with wing-shaped protrusions and to fix the bicycle handle to the handlebar by means of a clamping element. This is advantageous insofar as the ball of the thumb transmits forces onto the support element for the ball of the thumb and a twisting of the bicycle handle on the handlebar is avoided due to the fixation by clamping. The design of the inner sleeve, specifically also in combination with the wing-shaped protrusion and the clamping element, preferably is as described in EP 1 537 014. However, it is preferred that the clamping element is arranged in particular on the inner side of the inner part directed towards the handlebar stem.

In a further preferred embodiment of the disclosure, a rear edge of the support element for the ball of the thumb extends substantially in parallel with the centre line of the outer part. Here, the rear edge is the edge directed towards the user, when in the mounted state. For a further enhancement of the bicycle handle ergonomics, and thus for the enhancement of the hand position, the outer edge is curved downward in particular, when seen in rear view. In the mounted state, the outer edge of the support element for the ball of the thumb directed towards the user is, as such, first situated approximately on the centre line of the outer part and then extends downward in a curve, i.e. towards the road.

In a particularly preferred embodiment, the bicycle handle of the disclosure is fixed on the handlebar by clamping. For this purpose, it is preferred that the bicycle handle has an inner sleeve, in particular of rigid plastic material. In a preferred embodiment, the inner sleeve is surrounded by a clamping means on the inner side or the outer side, the sleeve possibly having at least one longitudinal slot in this region. The inner side of the sleeve is the side of the bicycle handle directed towards the handlebar interior in the mounted state. Accordingly, the outer side is the side of the bicycle handle directed outward away from the handle bar.

It is preferred to provide a clamping element with an outer contour shaped such that it is integrated in the bicycle handle or the outer contour of the bicycle handle. Thus, disturbing ledges or steps are avoided that may cause pressure marks on the hand.

Preferably, the clamping is effected on the outer side of the bicycle handlebar, since no further elements, such as brake handles and shift levers, are fastened to the handlebar in this region and the corresponding clamp is therefore easier to access.

In order to achieve a good integration also for a clamping element arranged on the outer side of the outer part of the bicycle handle, the support element for the ball of the thumb has a first protrusion extending into the clamping element. The first protrusion is preferably arranged radially beside the clamping element and protrudes axially or longitudinally into the clamping element. Preferably, the outer part has a second protrusion that also extends into the clamping means, with the two protrusions preferably being arranged opposite each other. The two protrusions thus define a space between them. The clamping element is arranged in the opening thus formed.

With clamping element, which in a preferred embodiment is arranged in the outside portion of the outer part, it is preferred that the same has a convexly curved outer side. The latter merges into the outer sides of the first and/or the second protrusion, in particular in a smooth manner.

Further, the outer part may be provided, in particular integrally formed with a bar end. The bar end or gripping extension serves to change the gripping position and is preferably oriented such that it is directed forward substantially in parallel with the traveling direction, i.e. in the traveling direction.

The following is a detailed description of the disclosure with reference to preferred embodiments and to the accompanying drawings.

### BRIEF DESCRIPTION OF THE DRAWINGS

In the Figures:

FIG. 1 is a schematic top plan view on a first preferred embodiment of a bicycle handle according to the present disclosure,

FIG. 2 is a schematic side elevational view in the direction of the arrow II in FIG. 1,

FIG. 3 is a schematic side elevational view of a clamping element in the direction of the arrow III in FIG. 1,

FIG. 4 is a schematic top plan view on a sleeve with a wing-shaped protrusion, the sleeve being arranged inside the bicycle handle,

FIG. 5 is a schematic top plan view on a second, preferred embodiment of a bicycle handle,

FIG. 6 is a schematic side elevational view in the direction VI in FIG. 5, and

FIG. 7 is a schematic side elevational view in the direction of the arrow III in FIG. 5.

### DETAILED DESCRIPTION OF THE PREFERRED EMBODIMENT

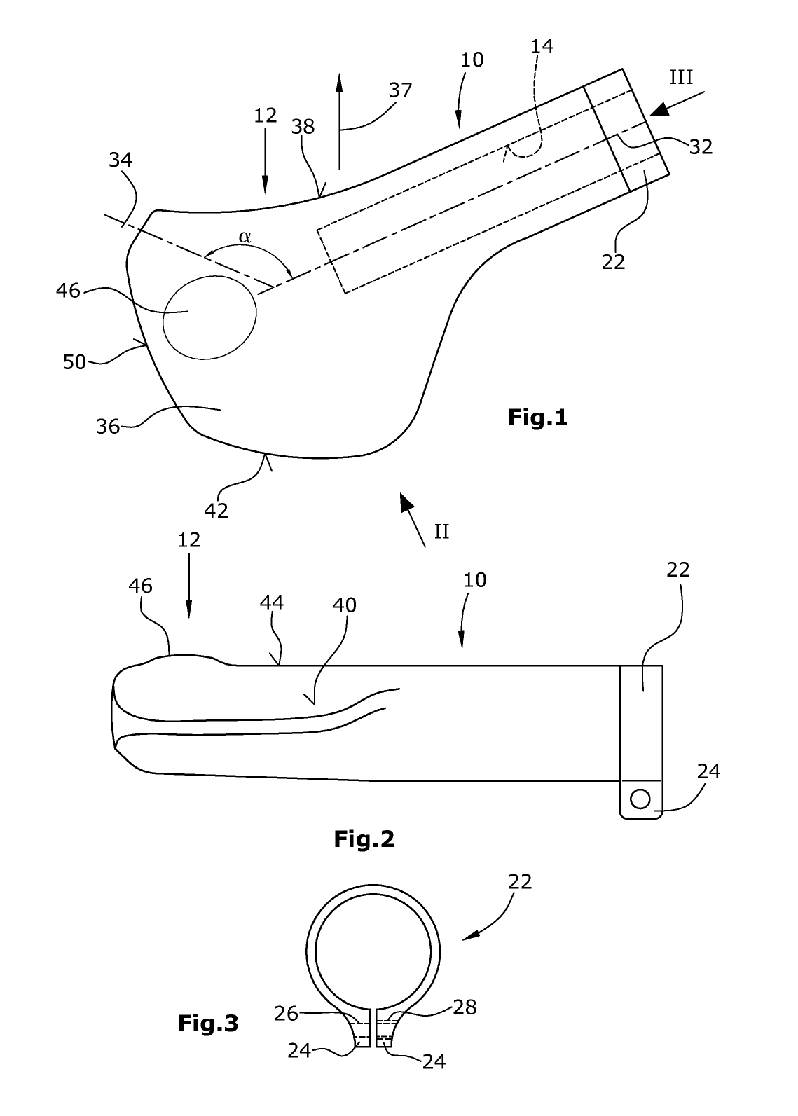

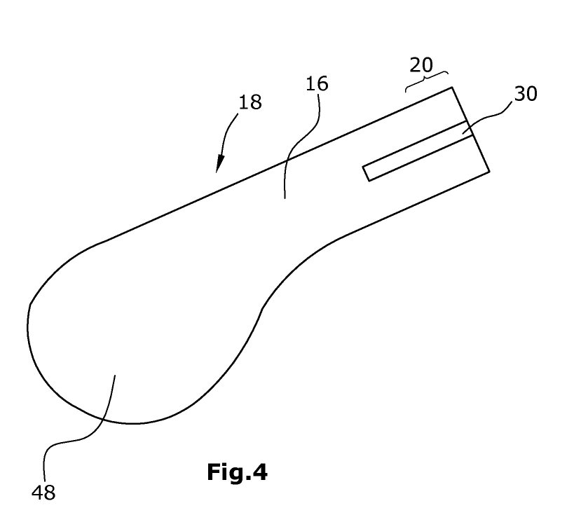

The bicycle handle of the present disclosure comprises an inner part 10 and an outer part 12, wherein the inner part 10 merges into the outer part 12 and the two parts are in particular integrally formed. In the inner part 10, a circular cylindrical opening 14 is provided that is defined by a circular cylindrical part 16 (FIG. 4) of a sleeve 18. If the bicycle handle of the present disclosure is a bicycle handle that is clampingly fastened to the handlebar, the sleeve protrudes from the inner part 10 by a clamping portion 20 so that a bracket-like clamping element 22 (FIGS. 1 and 3) can be provided. The clamping element 22 has protrusions 24 which are in particular directed downward when in the mounted state. The protrusions are provided with a bore 26 having a thread 28 so that a clamping screw, not illustrated herein, can be inserted into the same from the left in FIG. 3. Further, it is preferred that the sleeve 18 has a sleeve slot 30 in the region 22, where the clamping is effected.

The inner part, which has a substantially cylindrical outer contour, has a centre line which, in the mounted state, coincides with the centre line 32 of the handlebar end. Further, the outer part also has a centre line 34 whose position is independent of a support element for the ball of the thumb 36. The centre line 34 of the outer part 12 encloses an angle a with the centre line 32 of the inner part 10, which angle is arranged, with respect to the traveling direction 37, in the traveling direction. The angle a preferably ranges from 100°-170°, in particular from 120°-150°, and particularly preferred from 130°-140°. The bicycle handle of the present disclosure is thus designed such that, with reference to the traveling direction 37, it has an outer part 12 that is angled in the traveling direction 37 with respect to the inner part 10.

20

In the embodiment illustrated, a front edge 38 of the bicycle handle, directed in the traveling direction, is thus concavely shaped. The front edge 38 is a common front edge of the inner part 10 and the outer part 12.

The wing-shaped support element for the ball of the thumb forms a support surface 40 for the ball of the thumb. When the bicycle handle is gripped in the usual way, the ball of the thumb thus rests on the support surface 40 for the ball of the thumb. Owing to the inventive angular offset between the inner part 10 and the outer part 12, the wrist is turned back against the angular offset caused by the curvature of the handlebar. An ergonomic position of the wrist is thereby ensured. Further, the bicycle handle should be mounted to the handlebar in such a manner that the support surface 40 for the ball of the thumb is arranged substantially horizontally, possibly slightly sloping towards the rider.

A rear edge 42 (FIG. 1) of the support element 36 for the ball of the thumb is preferably directed such that it extends substantially in parallel with the centre line 34 of the outer part 12.

In a preferred embodiment of the disclosure a bulge 46 is provided on a top face 44 of the outer part 12. The bulge, which is located approximately in the middle of the outer part 12, assists in the correction of the position of the hand.

In a preferred embodiment, the sleeve 18 (FIG. 4), which is provided in particular when the bicycle handle is fastened by clamping using a clamping means 22, comprises a wing-shaped protrusion 48. The latter protrudes into the support element 36 for the ball of the thumb in the manner of skeleton.

Further, a bar end not illustrated can be connected with the outer side 50 of the outer part 12, in particular integrally formed with the outer part 12. The bar end or gripping extension is arranged such that it is substantially directed in the traveling direction 37 and is designed such that it is slightly sloping upward with respect to a horizontal line, when in the mounted state. Thereby, a second gripping position is formed for further relief of the hand.

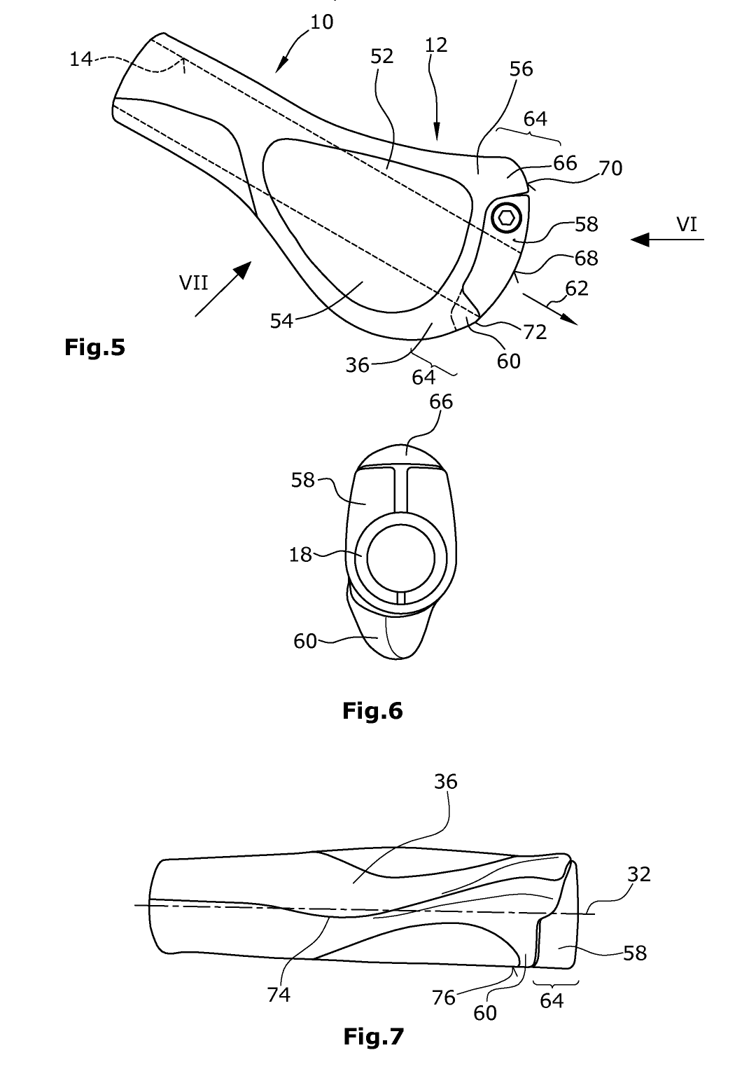

In another preferred embodiment of a bicycle handle illustrated in FIGS. 5 to 7, with which basically the same effects are achieved as with the bicycle handle illustrated in FIGS. 1 to 4, similar or identical components are marked by the same reference numerals.

The bicycle handle illustrated in FIG. 5, which is a right-side bicycle handle in the mounted state, also has an inner part 10 and an outer part 12. An inner circular cylindrical opening 14 serves the purpose of fastening the handle to a bicycle handlebar, wherein a sleeve, as described in the first embodiment, is preferably arranged inside the opening 14. As indicated by dotted lines, the sleeve may comprise mutually opposite protrusions 52, 54. The protrusion 54 extends into the support element 36 for the ball of the thumb and is thus substantially directed in a direction opposite to the traveling direction 37. Correspondingly, the opposite protrusion 52 protrudes into the part 56 of the outer part 12 directed in the traveling direction.

In the embodiment illustrated in FIGS. 5 to 7, it is particularly preferred that a clamping element 58 is arranged at an outer side of the handle, i.e. on the right in case of a right-side bicycle handle. As described in connection with the first embodiment and visible in FIG. 6, the clamping element 58 surrounds the sleeve 18 to fix the sleeve, and thus the bicycle handle, to the handlebar by clamping.

The support element 36 for the ball of the thumb has an outward directed protrusion 60 on its side directed opposite to the traveling direction 37, i.e. the side directed towards the user. This protrusion protrudes into the area of the clamping element 58. The first protrusion 60 thus extends longitudinally into the clamping area 64 illustrated by two brackets. Seen perpendicularly to the longitudinal direction 62, the first protrusion 60 is situated outside the clamping means 58.

In a particularly preferred embodiment, also the part 56 of the outer part 12 has a second protrusion 66. The same also extends longitudinally 62 into the clamping area 64 of the clamping element 58, while being arranged beside the same in a direction perpendicular to the longitudinal direction 62.

By providing the two protrusions 60, 66, it is possible to integrate the clamping means into the handle. In particular, a preferably convexly curved outer side 68 of the clamping element 58 merges into outer sides 70, 72 of the two protrusions 60, 66, which are also convexly curved. The upper side and the lower side of the clamping element 58 likewise merge into the upper side of the outer part 12 and the lower side of the outer part 12, respectively, and, in a preferred embodiment, do so in a continuous manner.

For an enhancement of the ergonomics of the hand position, the support element 36 for the ball of the thumb is designed such that an outer edge 74 (FIG. 7) directed towards the rider is formed with a curved shape. Starting near an upper side 76 of the outer part, the outer edge 74 runs downward in a curve to then extend substantially in parallel with a centre line 32 of the bicycle handle again.

What is claimed is:

1. A bicycle handle, in particular for curved handlebars, comprising
an inner part with an opening for receiving a handlebar and an outer part adjoining the inner part,
wherein the outer part is angled with respect to the inner part.

2. The bicycle handle of claim 1, further comprising a centre line of the outer part includes an angle with a centre line of the inner part that preferably-is in a range from 100°-170°.

3. The bicycle handle of claim 1, wherein the outer side of the inner part merges smoothly into the outer side of the outer part.

4. The bicycle handle of claim 1, further comprising a frontward common front edge of the inner part and the outer part, which edge is directed in the traveling direction, is concavely curved.

5. The bicycle handle of claim 1, wherein the outer part comprises a support element for the ball of the thumb directed opposite to the traveling direction.

6. The bicycle handle of claim 5, wherein the rear edge of the support element for the ball of the thumb extends substantially in parallel with the centre line of the outer part.

7. The bicycle handle of claim 1, wherein the rear edge of the support element for the ball of the thumb is designed with a downwardly curved shape.

8. The bicycle handle of claim 1, wherein the outer part has a protrusion formed on the upper side for assisting in the correction of the hand position.

9. The bicycle handle of claim 1, further comprising an inner sleeve surrounded by the inner part, said sleeve preferably defining the opening.

10. The bicycle handle of claim 9, wherein the sleeve is connected with an in particular wing-shaped protrusion protruding into the support element for the ball of the thumb.

11. The bicycle handle of claim 1, further comprising a clamping element for fixing the bicycle handle to the handlebar by clamping, the element preferably being arranged at the inner part.

12. The bicycle handle of claim 1, further comprising a clamping element preferably arranged at the outer part, said element preferably being integrated in an outer contour of the outer part.

13. The bicycle handle of claim 12, wherein the support element for the ball of the thumb has a first protrusion extending into the clamping element.

14. The bicycle handle of claim 12, wherein the outer part has a second protrusion extending into the clamping element.

15. The bicycle handle of claim 12, wherein the outer side of the clamping element is convexly curved.

16. The bicycle handle of claim 1, wherein the outer part is connected, preferably integrally formed, with a bar end.
